(19) United States
(12) Patent Application Publication
(10) Pub. No.: US 2026/0283180 A1
(43) Pub. Date: Sep. 24, 2026

(54) METHOD FOR TREATING COFFEE MATERIALS USING CRITICAL-STATE GAS TREATMENT

(71) Applicant: SoCal Technical Enterprises, LLC, San Diego, CA (US)

(72) Inventor: Robert Falken, San Diego, CA (US)

(21) Appl. No.: 19/574,211

(22) Filed: Mar. 20, 2026

Related U.S. Application Data
(60) Provisional application No. 63/775,325, filed on Mar. 21, 2025.

(51) Int. Cl. A23F 5/16

(52) U.S. Cl. CPC A23F 5/166

(57) ABSTRACT

A method is disclosed for treating a coffee material by placing the coffee material in a pressure vessel, exposing the coffee material to a critical-state gas, and maintaining the coffee material under conditions of pressure and temperature sufficient to alter the relative concentration of one or more roast-derived phenolic compounds associated with bitterness. In certain embodiments, the critical-state gas comprises carbon dioxide under supercritical conditions and ethanol is present as a co-solvent. The treated coffee material may exhibit a modified chromatographic profile of bitterness-associated phenolic compounds while substantially preserving caffeine content.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### CROSS-REFERENCE TO RELATED APPLICATIONS

This application claims the benefit of U.S. Provisional Patent Application No. 63/775,325, filed Mar. 21, 2025, the entire disclosure of which is incorporated herein by reference.

### BACKGROUND OF THE INVENTION

### Field of the Invention

The present invention relates generally to food processing and, more particularly, to methods for treating coffee materials using critical-state gases. In certain embodiments, the invention relates to the treatment of roasted, partially roasted, or unroasted coffee beans with critical-state gases, such as carbon dioxide under supercritical conditions, under controlled pressure and temperature conditions to modify roast-derived chemical compounds associated with flavor characteristics.

### Description of Related Art

Coffee is one of the most widely consumed beverages worldwide and is produced from roasted seeds of plants of the genus Coffea, including Coffea arabica and Coffea canephora. The flavor profile of coffee arises from a complex mixture of volatile and nonvolatile compounds formed during roasting. Among these compounds are chlorogenic acids and their derivatives. Chlorogenic acids present in coffee beans undergo chemical transformation during roasting to form chlorogenic acid lactones and related phenolic derivatives, which are widely recognized contributors to bitterness and astringency in roasted coffee beverages.

Chlorogenic acids (CGAs) are among the most abundant phenolic compounds in green coffee beans and are widely recognized as important precursors influencing coffee flavor development during roasting. In various reports, chlorogenic acids may represent approximately 4% to approximately 14% of the dry matter composition of green coffee beans, depending on coffee species, cultivation conditions, and processing methods. During the roasting process, chlorogenic acids undergo thermal degradation reactions including dehydration and lactonization, resulting in the formation of chlorogenic acid lactones and related phenolic derivatives associated with bitterness in roasted coffee. Chlorogenic acid lactones such as 3-caffeoylquinic lactone and 4-caffeoylquinic lactone are particularly associated with bitterness and astringency in roasted coffee. The concentration of these lactones typically increases during early and medium roasting stages and may subsequently transform into additional phenolic compounds as roasting continues. Conversely, chlorogenic acid levels generally decrease during roasting due to thermal degradation reactions that produce quinic acid derivatives and corresponding lactones.

Roasting generates a diverse mixture of chlorogenic acid derivatives and related phenolic compounds. Numerous minor chlorogenic acid derivatives may also be present in roasted coffee, including multiple caffeoylquinic, feruloylquinic, and related hydroxycinnamate derivatives.

These phenolic compounds, including chlorogenic acids, chlorogenic acid lactones, quinic acid derivatives, and related hydroxycinnamate species, collectively influence bitterness and cup quality. The distribution and accessibility of such compounds within the coffee matrix may vary depending on roasting conditions, particle structure, and the physicochemical environment to which the coffee material is exposed.

During roasting, naturally occurring chlorogenic acids degrade and form chlorogenic acid lactones and other phenolic compounds that contribute to bitterness in brewed coffee. The concentration and distribution of these compounds depend on roasting conditions, bean composition, and post-roast processing. Excessive formation of such compounds may negatively affect the sensory characteristics of coffee, particularly in darker roasts or lower-quality beans. Chlorogenic acids and their corresponding lactones contribute significantly to the bitterness, acidity, and astringency characteristics of roasted coffee beverages.

The perception of bitterness in coffee arises from complex interactions among multiple chemical compounds within the coffee matrix. Bitterness perception is therefore not determined solely by the concentration of a single compound but instead arises from interactions among numerous phenolic, organic acid, and aromatic compounds. Certain compounds may enhance perceived bitterness while others act as bitterness suppressors when present in mixtures, resulting in a complex sensory network that determines the final taste profile of brewed coffee.

Efforts to reduce bitterness in coffee have included adjustments to roasting conditions, enzymatic hydrolysis of chlorogenic acid derivatives, and various pre-roast treatments of green coffee beans. While such approaches may influence the formation or degradation of bitterness-associated compounds, they often require biological reagents, introduce additional processing complexity, or alter desirable flavor compounds generated during roasting. As a result, these methods may not provide an efficient or scalable approach for modifying bitterness in already roasted coffee materials.

Quinic acid is a naturally occurring metabolite of the shikimate pathway found in numerous plant-derived products, including fruits, coffee, and fermented beverages. The compound may occur either in free form or as esters such as chlorogenic acids, which are particularly abundant in coffee matrices. Analytical techniques for the determination of quinic acid in food materials have been reported, including chromatographic methods such as hydrophilic interaction liquid chromatography coupled with ultraviolet detection. However, such analytical methods are generally optimized for laboratory analysis and may require relatively extensive sample preparation and analysis times, limiting their suitability for rapid or industrial-scale processing environments.

Advances in chromatographic and spectrometric analytical methods have enabled detailed characterization of bitterness-associated compounds in coffee. High-performance liquid chromatography and related techniques have been widely used to quantify chlorogenic acids, chlorogenic acid lactones, and organic acids in coffee matrices. Studies have demonstrated that roasting conditions strongly influence the distribution of these compounds, with chlorogenic acids generally decreasing during roasting while chlorogenic acid lactones and related phenolic compounds are formed. These analytical approaches provide a framework for monitoring chemical changes in coffee during processing and for evaluating modifications to bitterness-associated compound profiles.

Supercritical carbon dioxide processing is widely used in the coffee industry, particularly for decaffeination of green coffee beans. In such processes, carbon dioxide under supercritical conditions is used as an extraction medium to selectively remove caffeine from coffee. These techniques typically focus on extraction and separation of target compounds rather than modification of the chemical composition of roasted coffee materials.

Despite these developments, there remains a need for methods capable of modifying bitterness-associated compounds in coffee materials, including roasted coffee beans, without substantially removing desirable flavor components or caffeine. In particular, methods that can be applied after roasting and that utilize scalable processing technologies remain of interest for improving coffee flavor characteristics.

### SUMMARY OF THE INVENTION

The present invention provides methods for treating coffee materials using a critical-state gas. In various embodiments, coffee materials including roasted coffee beans, partially roasted coffee beans, green coffee beans, ground coffee, or coffee-derived materials are exposed to a critical-state gas selected from carbon dioxide, nitrogen, argon, or mixtures thereof under controlled pressure and temperature conditions within a pressure vessel. As used herein, the term “critical-state gas” includes a gas maintained under supercritical conditions and a gas maintained under near-supercritical conditions, each relative to the critical point of the gas. In certain embodiments, a food-grade co-solvent such as ethanol may be present during treatment, and in preferred embodiments roasted coffee beans are exposed to carbon dioxide under supercritical conditions in the presence of ethanol as a co-solvent.

In some embodiments, the coffee material is treated within a pressure vessel at pressures ranging from approximately 10 bar to approximately 400 bar and at temperatures ranging from approximately 20° C. to approximately 80° C. for a treatment period sufficient to modify roast-derived phenolic compounds associated with bitterness, including chlorogenic acid lactones and related compounds. In preferred embodiments, the pressure ranges from approximately 50 bar to approximately 350 bar, and in more preferred embodiments the pressure ranges from approximately 150 bar to approximately 300 bar, with certain embodiments employing pressures of approximately 200 bar. In preferred temperature embodiments, the temperature ranges from approximately 25° C. to approximately 70° C., and in more preferred embodiments the temperature ranges from approximately 31° C. to approximately 60° C., with certain embodiments employing temperatures of approximately 40° C. The treatment period may vary depending on the form of the coffee material and the desired degree of chemical modification. The treatment may be applied after roasting or at other stages of coffee processing and may be conducted in batch, semi-continuous, or continuous reactor systems.

In certain embodiments, the disclosed process modifies the relative composition of bitterness-associated phenolic compounds in coffee while substantially preserving caffeine content and key organic acids. In some embodiments, the disclosed process reduces the relative concentration of one or more chlorogenic acid lactones. In some additional embodiments, the disclosed process reduces a relative abundance of one or more bitterness-associated phenolic compounds by at least about 5%, optionally by at least about 10%, at least about 15%, at least about 20%, or at least about 35%, relative to untreated coffee material. Unlike conventional decaffeination processes that extract caffeine from green coffee beans, the present invention may be applied to coffee materials at various stages of processing, including roasted, partially roasted, or unroasted coffee materials, and is directed to alteration of roast-derived compounds rather than caffeine removal.

In contrast to conventional supercritical fluid processes that are primarily directed toward extraction and removal of specific compounds (e.g., decaffeination), the present disclosure is directed to the modification, redistribution, or alteration of compounds within the coffee matrix. In certain embodiments, the critical-state gas is maintained in contact with the coffee material under conditions that promote interaction with internal constituents of the coffee matrix, rather than bulk removal of such constituents from the material. Such interaction may alter the relative concentration, spatial distribution, accessibility, partitioning, or chromatographic profile of one or more roast-derived phenolic compounds associated with bitterness.

The process may be carried out in pressure vessels capable of maintaining critical-state gas conditions, including laboratory-scale reactors and industrial-scale systems. The disclosed methods may be adapted for treatment of whole beans, ground coffee, or other coffee-derived materials and may be scaled for commercial processing.

### BRIEF DESCRIPTION OF THE DRAWINGS

The accompanying drawings illustrate various aspects and embodiments of the present invention disclosed herein but should not be construed as restricting the scope of the invention in any manner. In the drawings, like reference numerals refer to the same or similar elements or components.

FIG. 1 illustrates a schematic diagram of a critical-state gas treatment system configured to expose coffee materials to a critical-state gas.

FIG. 2 illustrates an example process flow for treating coffee materials using critical-state gas treatment.

### DETAILED DESCRIPTION OF THE INVENTION

The present invention relates to methods for treating coffee materials using a critical-state gas. In various embodiments, coffee materials are exposed to a critical-state gas under controlled pressure and temperature conditions within a pressure vessel, thereby altering the relative concentration of one or more roast-derived phenolic compounds associated with bitterness.

As used herein, the term “coffee material” refers to coffee in any form suitable for treatment, including whole coffee beans, partially roasted coffee beans, green coffee beans, ground coffee, coffee extracts, or other coffee-derived materials. Coffee materials may originate from any species of the genus Coffea, including but not limited to Coffea arabica, Coffea canephora, Coffea liberica, and Coffea excelsa. The coffee material may be produced using conventional coffee processing methods including wet processing, dry processing, semi-washed processing, or other post-harvest treatments.

The term “critical-state gas” includes a gas maintained under supercritical conditions and a gas maintained under near-supercritical conditions, each relative to the critical point of the gas. In some embodiments, the critical-state gas comprises carbon dioxide. In other embodiments, the critical-state gas comprises a gas selected from carbon dioxide, nitrogen, argon, and mixtures thereof.

“Near-supercritical conditions” refers to pressure and temperature conditions at, approaching, or within a defined range of the critical point of the gas, including conditions sufficiently close to the critical point to provide transport, diffusivity, solvating, or matrix-penetration characteristics useful for treatment of the coffee material.

In certain embodiments, the coffee material may also comprise intermediate or processed coffee products including coffee slurry, coffee concentrates, soluble coffee materials, or partially extracted coffee materials. Such materials may be treated using the methods disclosed herein in order to modify chemical components associated with bitterness or flavor characteristics.

Coffee roasting produces a complex mixture of chemical compounds that contribute to aroma, flavor, and mouthfeel. During roasting, naturally occurring chlorogenic acids present in green coffee beans undergo thermal transformation to form chlorogenic acid lactones through intramolecular ester formation reactions, compounds known to contribute to bitterness in roasted coffee.

The methods disclosed herein employ a pressure vessel (reactor) capable of maintaining critical-state gas conditions. As used herein, the terms ‘pressure vessel’ and ‘reactor’ may be used interchangeably unless otherwise specified. In various embodiments, the reactor may comprise a pressure vessel constructed from materials capable of withstanding elevated pressures and temperatures, such as stainless steel. The reactor may include systems for gas introduction, pressure control, temperature control, mixing or agitation, and controlled depressurization. In certain embodiments, the reactor may further include gas recirculation systems capable of maintaining uniform critical-state gas distribution throughout the coffee material.

In various embodiments, the reactor may comprise different reactor configurations suitable for pressurized processing of solid materials. Such configurations may include stirred reactors, packed-bed reactors, fluidized-bed reactors, rotating pressure vessels, or continuous flow systems capable of maintaining supercritical or near-supercritical conditions. The reactor may further include internal agitation systems, gas circulation systems, or other mechanisms to promote uniform exposure of the coffee material to the critical-state gas.

In certain embodiments, the pressure vessel may be configured as a laboratory-scale reactor, pilot-scale reactor, or industrial-scale processing system. Reactor volumes may vary depending on the scale of operation and may range from approximately one liter to several thousand liters or more. The disclosed process may therefore be implemented for experimental, pilot, or commercial coffee processing applications.

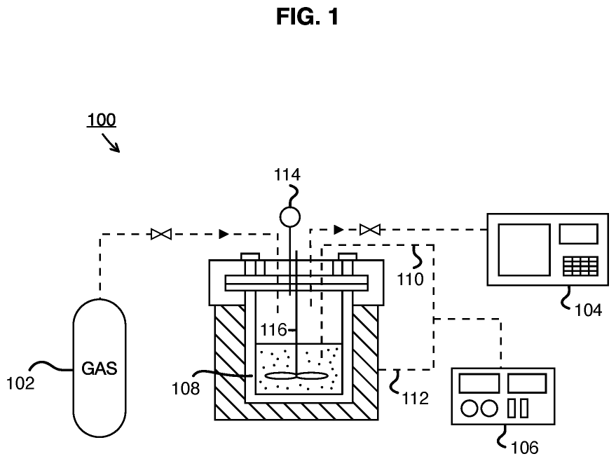

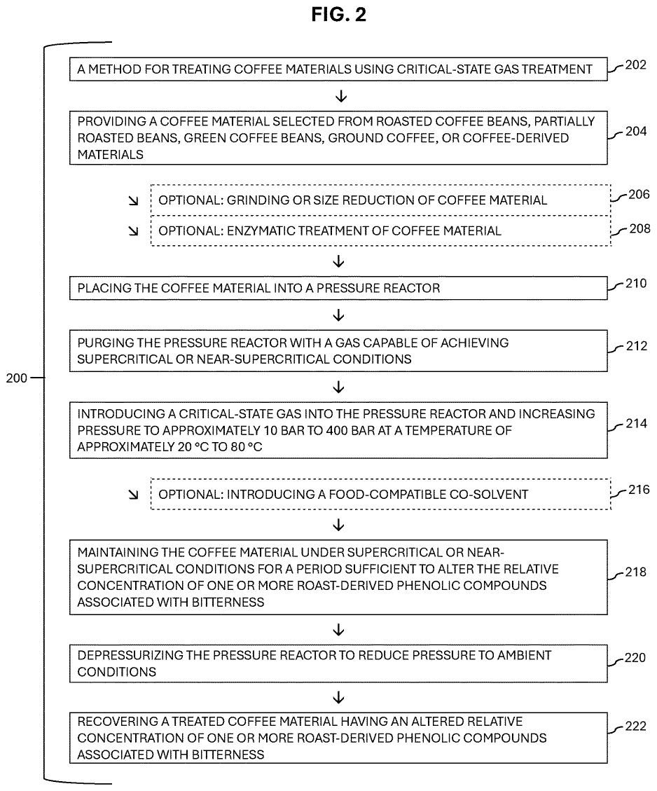

FIG. 1 illustrates an example system 100 configured to treat coffee materials using a critical-state gas. The system 100 may be used to implement the methods described herein, including method 200 of FIG. 2.

The system 100 includes a reactor 108 (pressure vessel) configured to receive a coffee material for treatment. The reactor 108 may be constructed from materials capable of withstanding elevated pressures and temperatures and may be configured for batch, semi-continuous, or continuous operation. In various embodiments, the reactor 108 may include internal mixing or agitation components.

A gas supply 102 is provided in fluid communication with the reactor 108. The gas supply 102 may comprise a pressurized gas source, such as a cylinder or bulk storage system, containing a gas capable of providing a critical-state gas, including carbon dioxide, nitrogen, argon, or mixtures thereof.

A gas control component 104 is configured to regulate delivery of the gas from the gas supply 102 to the reactor 108. In certain embodiments, the gas control component 104 may comprise one or more gas regulators, mass flow controllers, metering systems, gas analyzers such as a gas chromatograph (GC), pressure-control components, purity-monitoring components, or combinations thereof configured to control gas composition, flow rate, pressure, or purity prior to introduction into the reactor.

A control system 106 is provided to regulate operating conditions within the system 100. The control system 106 may include temperature control and motor control components configured to control heating elements and mixing systems associated with the reactor 108.

A temperature sensor 110, such as a thermocouple, is associated with the reactor 108 and is configured to monitor the temperature within the reactor during operation. The temperature sensor 110 may provide feedback to the control system 106 for maintaining desired operating conditions.

A heater 112 is provided to supply thermal energy to the reactor 108 and maintain the temperature of the coffee material and pressurized gas within a desired range. The heater 112 may be controlled by the control system 106.

A pressure measurement device 114, such as a pressure gauge, is provided to monitor the pressure within the reactor 108. The pressure measurement device 114 may be used to ensure that the system operates within desired pressure ranges, including pressure ranges suitable for maintaining critical-state gas conditions.

A mixing component 116, such as a stirrer, is associated with the reactor 108 and is configured to agitate the contents of the reactor. Agitation may improve interaction between the pressurized gas and the coffee material and promote uniform treatment conditions.

In operation, gas from the gas supply 102 may be introduced into the reactor 108 through the gas control component 104. The pressure and temperature within the reactor may be controlled using the control system 106, heater 112, and temperature sensor 110 to achieve critical-state gas conditions. The mixing component 116 may be operated to promote uniform exposure of the coffee material to the critical-state gas. The pressure within the reactor may be monitored using the pressure measurement device 114 during treatment.

Additional components such as valves, flow controllers, gas recycling systems, co-solvent injection systems, or safety devices may be included in the system 100 without departing from the scope of the invention.

Having described example systems for implementing the disclosed methods, a process flow for operating the system 100 is now described with reference to FIG. 2. FIG. 2 illustrates an example method 200 for treating coffee materials using critical-state gas treatment. The method 200 includes a sequence of operations represented by blocks 202-222, each of which may correspond to one or more process steps. The blocks may be performed in any suitable order, and one or more blocks may be omitted, combined, or repeated without departing from the scope of the invention.

At block 202, the method is initiated for treating coffee materials using critical-state gas treatment. The method may be applied to a variety of coffee materials and processing stages as described herein.

At block 204, a coffee material is provided. The coffee material may be selected from roasted coffee beans, partially roasted coffee beans, green coffee beans, ground coffee, coffee extracts, or other coffee-derived materials.

At block 206, which is optional, the coffee material may be subjected to grinding or size reduction. Grinding or comminution may increase the surface area of the coffee material and facilitate interaction with the critical-state gas during subsequent processing.

At block 208, which is optional, the coffee material may be subjected to enzymatic treatment prior to exposure to the critical-state gas. Suitable enzymes may include those capable of modifying phenolic compounds present in the coffee matrix.

At block 210, the coffee material is placed into a pressure vessel configured to withstand elevated pressures and temperatures. The pressure vessel may comprise a stirred reactor, packed-bed reactor, fluidized-bed reactor, rotating pressure vessel, or continuous flow system.

At block 212, the pressure vessel is purged with a gas capable of achieving supercritical or near-supercritical conditions in order to remove air or other gases present within the vessel.

At block 214, a critical-state gas is introduced into the pressure vessel, and the pressure is increased to a desired level. In various embodiments, the pressure may range from approximately 10 bar to approximately 400 bar and the temperature may range from approximately 20° C. to approximately 80° C.

At block 216, which is optional, a co-solvent may be introduced into the pressure vessel prior to or during pressurization. Suitable co-solvents may include food-compatible liquids such as alcohols, polyols, esters, ketones, ethers, organic acids, nitriles, water, or combinations thereof.

At block 218, the coffee material is maintained under supercritical or near-supercritical conditions for a period sufficient to alter the relative concentration of one or more roast-derived phenolic compounds associated with bitterness. In some embodiments, such alteration comprises reducing the relative concentration of one or more chlorogenic acid lactones, modifying a chromatographic profile of one or more roast-derived phenolic compounds associated with bitterness relative to untreated coffee material, or reducing a relative abundance of one or more bitterness-associated phenolic compounds by at least about 5% relative to untreated coffee material.

At block 220, the pressure within the pressure vessel is reduced through a controlled depressurization process.

At block 222, the treated coffee material is recovered from the pressure vessel. The treated coffee material may exhibit an altered relative concentration of one or more roast-derived phenolic compounds associated with bitterness compared to untreated coffee material.

The operations of method 200 may be performed in any suitable order, and one or more steps may be omitted, combined, or repeated without departing from the scope of the invention.

### Critical-State Gas Treatment

In various embodiments, the coffee material is placed within the pressure vessel and exposed to a critical-state gas. Suitable gases include carbon dioxide, nitrogen, argon, or mixtures thereof. Carbon dioxide is particularly preferred due to its well-known supercritical properties and compatibility with food processing applications.

Supercritical carbon dioxide typically exists above a critical temperature of approximately 31° C. and a critical pressure of approximately 73 bar. Under such conditions, the fluid exhibits properties intermediate between a liquid and a gas, including high diffusivity and adjustable solvent strength.

Near-supercritical conditions may include pressures and temperatures approaching or exceeding the critical point of the selected gas.

In certain embodiments, the reactor may be purged with the selected gas prior to reaching supercritical conditions in order to remove air or other gases present within the reactor chamber.

The coffee material may then be exposed to the critical-state gas within the pressure vessel at pressures ranging from approximately 10 bar to approximately 400 bar and at temperatures ranging from approximately 20° C. to approximately 80° C. In preferred embodiments, the pressure ranges from approximately 50 bar to approximately 350 bar, and in more preferred embodiments the pressure ranges from approximately 150 bar to approximately 300 bar, with certain embodiments employing pressures of approximately 200 bar. In preferred temperature embodiments, the temperature ranges from approximately 25° C. to approximately 70° C., and in more preferred embodiments the temperature ranges from approximately 31° C. to approximately 60° C., with certain embodiments employing temperatures of approximately 40° C. The treatment period may vary depending on the desired degree of chemical modification and the form of the coffee material and may range from approximately 5 minutes to approximately 48 hours, with certain embodiments employing treatment periods of approximately one hour to approximately six hours.

Under supercritical conditions, the solvent strength of the supercritical fluid may be influenced by pressure, temperature, and the presence of co-solvents. Adjusting these parameters may influence the interaction between the supercritical fluid and compounds present in the coffee matrix. Accordingly, the treatment conditions may be adjusted to achieve desired modifications of bitterness-associated compounds.

### Optional Co-Solvent

In some embodiments, the critical-state gas treatment may be conducted in the presence of a co-solvent. Suitable co-solvents include food-grade liquids that are compatible with coffee processing. In certain embodiments, ethanol may be used as a preferred co-solvent. In some preferred embodiments, roasted coffee beans are exposed to carbon dioxide under supercritical conditions in the presence of ethanol as a co-solvent.

The co-solvent, or one or more co-solvents, may be introduced into the reactor prior to pressurization or during pressurization. In various embodiments, the co-solvent may be present in quantities ranging from approximately 0% to approximately 20% by volume relative to the total treatment-fluid composition. In preferred embodiments, the co-solvent is present in an amount ranging from approximately 1% to approximately 15% by volume, and in more preferred embodiments the co-solvent is present in an amount ranging from approximately 2% to approximately 10% by volume, with certain embodiments employing co-solvent concentrations of approximately 2% to approximately 5% by volume relative to the total treatment-fluid composition. Suitable co-solvents may include alcohols, polyols, esters, ketones, ethers, organic acids, nitriles, water, or combinations thereof, with representative examples including ethanol, methanol, water, ethyl acetate, propylene glycol, glycerol, and related compounds. In certain embodiments, the co-solvent is a food-compatible co-solvent.

Additional co-solvents may also be used, including but not limited to alcohols, polyols, esters, ketones, ethers, organic acids, nitriles, water, or combinations thereof. In certain embodiments, the co-solvent comprises a food-compatible co-solvent. Representative examples of suitable co-solvents may include ethanol, methanol, isopropanol, propanol, butanol, propylene glycol, glycerol, ethylene glycol, water, ethyl acetate, methyl acetate, acetone, methyl ethyl ketone, acetonitrile, dimethyl carbonate, dimethyl ether, or combinations thereof. The presence of a co-solvent may influence the solubility, mobility, or interaction of certain compounds within the coffee matrix during treatment, including phenolic compounds associated with bitterness. In certain embodiments, the co-solvent may increase the polarity of the supercritical fluid, thereby enhancing interaction between the supercritical phase and polar compounds present in the coffee matrix.

### Process Parameter Optimization

In certain embodiments, the effectiveness of the supercritical gas treatment may depend on several controllable process parameters including pressure, temperature, treatment duration, gas density, and the presence or concentration of optional co-solvents. Adjustment of these parameters may influence the degree to which the supercritical fluid interacts with compounds present in the coffee matrix and may therefore affect the resulting modification of bitterness-associated phenolic compounds.

Pressure may influence the density and solvent strength of the supercritical fluid. Increasing pressure generally increases the density of the supercritical phase, which may enhance its ability to penetrate the porous structure of roasted coffee materials and interact with phenolic compounds present within the coffee matrix. In various embodiments, pressures ranging from approximately 10 bar to approximately 400 bar may be employed. Higher pressures within this range may increase the mobility or solubility of certain compounds within the supercritical phase.

Temperature may also influence the behavior of the pressurized or supercritical fluid and the kinetics of chemical or physical interactions occurring during treatment. In various embodiments, the treatment may be conducted at temperatures ranging from approximately 20° C. to approximately 80° C. In preferred embodiments, the temperature ranges from approximately 25° C. to approximately 70° C., and in more preferred embodiments the temperature ranges from approximately 31° C. to approximately 60° C., with certain embodiments employing temperatures of approximately 40° C. Temperatures within these ranges may be suitable for maintaining supercritical or near-supercritical conditions while avoiding excessive thermal degradation of coffee components. In certain embodiments, moderate temperatures may facilitate interaction between the supercritical fluid and bitterness-associated compounds without substantially altering desirable aroma compounds.

Treatment duration may further affect the extent of modification of bitterness-associated compounds. In various embodiments, treatment periods may range from approximately 5 minutes to approximately 48 hours, depending on the desired degree of chemical modification and the form of the coffee material being treated. In preferred embodiments, treatment periods may range from approximately 30 minutes to approximately 24 hours, and in more preferred embodiments treatment periods may range from approximately 1 hour to approximately 12 hours, with certain embodiments employing treatment durations of approximately 2 hours to approximately 6 hours. Shorter treatment periods may be sufficient for modification of surface-accessible compounds in ground coffee or porous roasted beans, whereas longer treatment durations may facilitate deeper penetration of the supercritical fluid into the coffee matrix.

In certain embodiments, the presence of a co-solvent may further influence the interaction between the supercritical fluid and compounds present in the coffee matrix. Small quantities of polar co-solvents, such as ethanol, may increase the ability of the supercritical phase to interact with polar phenolic compounds including chlorogenic acid derivatives. The concentration of such co-solvents may be adjusted depending on the desired degree of compound modification.

The combination of pressure, temperature, treatment duration, and optional co-solvent concentration may therefore be optimized to achieve desired modifications in the chemical composition of the treated coffee material. Different parameter combinations may be selected depending on the roast level, bean composition, or processing stage of the coffee material.

### Interaction with Coffee Matrix

Under supercritical conditions, the pressurized gas can penetrate the porous structure of the coffee material. The supercritical fluid may interact with compounds present in the roasted coffee matrix, including phenolic compounds associated with bitterness.

Without being limited to a particular mechanism, the supercritical treatment may alter the distribution, mobility, or relative concentration of bitterness-associated compounds within the coffee matrix. The process may also facilitate removal or redistribution of certain volatile or semi-volatile compounds during depressurization.

In some embodiments, treatment of coffee materials according to the disclosed methods results in a modification of the relative composition of one or more roast-derived phenolic compounds associated with bitterness when compared to untreated coffee materials. Such compounds may include chlorogenic acid lactones, quinides, phenylindanes, and related phenolic derivatives formed during roasting. The resulting treated coffee material may exhibit a modified chromatographic profile of bitterness-associated phenolic compounds, including a modified chromatographic profile of the one or more roast-derived phenolic compounds associated with bitterness, relative to untreated coffee material while substantially preserving caffeine content.

In certain embodiments, the treated coffee material produced according to the disclosed methods exhibits a modified chemical composition relative to untreated coffee material. Such treated coffee materials may contain altered relative concentrations of roast-derived phenolic compounds associated with bitterness while maintaining substantially unchanged caffeine content. The resulting coffee product may therefore exhibit a modified chromatographic profile when analyzed using chromatographic techniques and may be characterized by reduced relative concentration of one or more chlorogenic acid lactones or reduced relative abundance of one or more bitterness-associated phenolic compounds.

In some embodiments, modification of bitterness-associated phenolic compounds may also influence the stability of the flavor profile of the treated coffee material during storage or distribution. Because compounds such as chlorogenic acid lactones, quinides, and related phenolic derivatives can contribute to the development of harsh or bitter flavor notes over time, altering the relative composition of these compounds may reduce the formation or perception of undesirable bitterness during extended storage. As a result, coffee materials treated according to the disclosed methods may exhibit improved flavor stability compared to untreated coffee materials, thereby potentially improving perceived product quality during distribution and storage.

### Depressurization

Following treatment, the reactor pressure may be gradually reduced through a controlled depressurization process. Depressurization may occur over a period of time sufficient to avoid excessive mechanical stress on the coffee material.

During depressurization, compounds dissolved or mobilized in the supercritical phase may be released from the coffee material. The treated coffee material may then be recovered from the reactor.

### Preferred Embodiment

In one preferred embodiment, roasted coffee beans are placed into a laboratory-scale pressure reactor. The reactor is purged with carbon dioxide and subsequently pressurized to approximately 200 bar at a temperature of approximately 40° C. Ethanol is introduced into the reactor as a co-solvent before or during pressurization, and the roasted coffee beans are exposed to carbon dioxide under supercritical conditions in the presence of ethanol as a co-solvent. The coffee material is maintained under these conditions for a period of time sufficient to allow the critical-state gas to penetrate the coffee matrix and alter the relative concentration of one or more roast-derived phenolic compounds associated with bitterness. After completion of the treatment period, the reactor is gradually depressurized and the treated coffee beans are recovered.

### Alternative Embodiments

Numerous variations of the disclosed method may be implemented by adjusting pressure, temperature, treatment duration, gas composition, or co-solvent concentration without departing from the scope of the invention. For example, treatment conditions may vary depending on the desired level of chemical modification. In various embodiments, suitable pressures may range from approximately 10 bar to approximately 400 bar. In preferred embodiments, pressures may range from approximately 50 bar to approximately 350 bar, and in more preferred embodiments pressures may range from approximately 150 bar to approximately 300 bar, with certain embodiments employing pressures of approximately 200 bar. In various embodiments, suitable temperatures may range from approximately 20° C. to approximately 80° C. In preferred embodiments, temperatures may range from approximately 25° C. to approximately 70° C., and in more preferred embodiments temperatures may range from approximately 31° C. to approximately 60° C., with certain embodiments employing temperatures of approximately 40° C. Treatment durations may range from approximately 5 minutes to approximately 48 hours, depending on the desired degree of chemical modification and the form of the coffee material being treated. In preferred embodiments, treatment durations may range from approximately 30 minutes to approximately 24 hours, and in more preferred embodiments treatment durations may range from approximately 1 hour to approximately 12 hours, with certain embodiments employing treatment durations of approximately 2 hours to approximately 6 hours.

The method may be applied to coffee materials at various stages of processing, including green coffee beans prior to roasting, partially roasted beans, fully roasted beans, ground coffee, or coffee extracts.

The disclosed process may also utilize different critical-state gases or combinations of gases, including carbon dioxide, nitrogen, argon, or mixtures thereof.

In certain embodiments, the disclosed supercritical or near-supercritical treatment may optionally be combined with additional modification techniques capable of altering bitterness-associated compounds present in the coffee matrix. For example, enzymatic treatments capable of hydrolyzing chlorogenic acid lactones or related phenolic compounds may be applied before, during, or after exposure of the coffee material to the pressurized fluid, including by introduction of one or more enzymes into the pressure vessel together with the coffee material.

Without being bound by theory, the supercritical or near-supercritical fluid may enhance interaction between the coffee matrix and compounds present therein or increase accessibility of target compounds within the roasted coffee structure. In certain embodiments, such interaction may occur without substantial depletion of target compounds from the coffee matrix.

In certain embodiments, suitable enzymes may include esterases, tannases, hydrolases, lipases, or combinations thereof capable of modifying chlorogenic acid lactones or related phenolic compounds present in the coffee matrix. Non-limiting examples of such enzymes may include hog liver esterase, chlorogenate esterase, tannase, palatase, or related enzymes derived from microbial, plant, or animal sources.

In some implementations, enzymatic treatment of the coffee material may be performed prior to exposure to the supercritical or near-supercritical fluid. For example, whole roasted coffee beans may be contacted with an aqueous solution comprising one or more enzymes capable of hydrolyzing chlorogenic acid lactones or related phenolic compounds. The enzymatic treatment may be conducted under conditions suitable for enzyme activity, such as temperatures ranging from approximately 20° C. to approximately 60° C. and treatment periods ranging from approximately 5 minutes to approximately 48 hours.

Following enzymatic treatment, the coffee beans may be dried to remove excess moisture and ground, milled, crushed, or otherwise comminuted to increase surface area. The dried and ground coffee material may then be subjected to the supercritical or near-supercritical gas treatment described herein, optionally in the presence of a co-solvent such as ethanol.

In such embodiments, the enzymatic treatment may partially hydrolyze chlorogenic acid lactones or related compounds prior to supercritical treatment, while the subsequent supercritical or near-supercritical processing may further modify the distribution or relative concentration of bitterness-associated phenolic compounds within the coffee matrix.

The methods described herein may be implemented using reactors of various capacities suitable for laboratory, pilot, or industrial processing. Reactor volumes may range from small laboratory reactors capable of processing tens or hundreds of grams of coffee material to industrial reactors capable of processing hundreds of kilograms or more per batch. Continuous or semi-continuous reactor systems may also be used to increase throughput in commercial processing environments.

### Industrial Processing and Scalability

The methods disclosed herein may be implemented in a wide range of processing environments including laboratory-scale experimentation, pilot-scale development, and large-scale commercial coffee production. The critical-state gas treatment process may therefore be adapted to equipment configurations capable of processing various quantities of coffee materials.

In laboratory embodiments, small pressure reactors may be used to evaluate process parameters and study chemical modifications of coffee materials. Such reactors may process relatively small quantities of coffee material, for example tens to hundreds of grams per batch, and may be used to determine suitable pressure, temperature, and treatment duration parameters.

In pilot-scale implementations, larger pressure vessels may be employed to process kilogram-scale quantities of coffee material. These systems may incorporate additional features including gas circulation systems, internal agitation mechanisms, and automated pressure control systems in order to improve treatment uniformity and process control.

For commercial-scale applications, industrial pressure vessels capable of processing hundreds of kilograms or more of coffee material per batch may be utilized. Such systems may be integrated into existing coffee processing facilities and may be configured to operate in batch, semi-continuous, or continuous modes. Industrial systems may include gas recycling systems, heat exchange systems, and automated process control systems to improve efficiency and scalability.

In certain embodiments, the supercritical gas used in the treatment process may be recovered following depressurization and reused in subsequent processing cycles. Gas recovery systems may improve process efficiency and reduce operating costs in large-scale processing environments.

The scalability of the disclosed process allows it to be implemented within existing coffee processing infrastructure without requiring fundamental changes to roasting or packaging operations. As a result, the methods described herein may be integrated into commercial coffee production workflows to improve flavor characteristics of roasted coffee materials.

### EXPERIMENTAL EXAMPLE

In one experimental example, roasted coffee beans were treated in a laboratory-scale pressure reactor using carbon dioxide under supercritical conditions. The reactor was purged with carbon dioxide and pressurized to approximately 200 bar at a temperature of approximately 40° C. In certain embodiments, a small amount of ethanol was present in the reactor during treatment. The coffee beans were maintained under these conditions for approximately three hours before controlled depressurization.

Following treatment, both treated and untreated control samples were analyzed using chromatographic methods to evaluate differences in phenolic compound profiles. Samples were ground and extracted using an aqueous methanol solution prior to analysis. The extracts were filtered and analyzed using high-performance liquid chromatography with ultraviolet detection. Chromatographic analysis of the treated samples indicated differences in the relative distribution of roast-derived phenolic compounds associated with bitterness, including chlorogenic acid lactones and related derivatives, while caffeine content and key organic acids remained substantially unchanged relative to untreated control samples.

In certain experimental embodiments, chromatographic analysis of treated coffee materials demonstrated measurable differences in the relative composition of bitterness-associated phenolic compounds compared with untreated control samples. In particular, treated samples exhibited reduced relative abundance of chlorogenic acid lactones while maintaining substantially unchanged caffeine levels. These results are consistent with modification of roast-derived phenolic compounds associated with bitterness while substantially preserving caffeine and other desirable coffee constituents.

### Example 1—Treatment of Roasted Coffee Beans Using Supercritical Carbon Dioxide

In one experimental embodiment, roasted coffee beans were treated using supercritical carbon dioxide in order to evaluate the effect of the disclosed process on bitterness-associated phenolic compounds. Commercially available medium-roast Arabica coffee beans were used as a representative coffee material. Approximately 170 grams of whole roasted coffee beans were placed into a laboratory-scale stirred pressure reactor having an internal volume of approximately two liters. Prior to pressurization, approximately 10 milliliters of ethanol were introduced into the reactor as a co-solvent. The reactor chamber was then sealed and purged with carbon dioxide to remove air present within the system. Following purging, carbon dioxide was introduced into the reactor, and the pressure was increased to approximately 200 bar. The reactor temperature was subsequently raised to approximately 40° C. while maintaining the internal pressure at approximately 200 bar. The coffee beans were maintained under these supercritical conditions for approximately three hours while the reactor contents were gently agitated. After completion of the treatment period, the reactor was gradually depressurized over a period of approximately 15 to 30 minutes, and the treated coffee beans were recovered from the reactor vessel. The recovered beans were stored in airtight containers prior to chemical analysis. The treated coffee beans were subsequently analyzed using chromatographic methods to evaluate changes in bitterness-associated phenolic compounds relative to untreated control samples.

### Example 2—Comparative Control Sample

For comparison purposes, a control sample of untreated roasted coffee beans was prepared. Approximately 170 grams of the same batch of roasted coffee beans used in Example 1 were reserved as an untreated control sample. The beans were stored in airtight containers under ambient laboratory conditions and were not subjected to supercritical gas treatment.

### Example 3—Chemical Analysis of Treated and Untreated Samples

To evaluate the effect of the supercritical gas treatment, both treated and untreated coffee samples were analyzed using high-performance liquid chromatography. Samples of approximately 5 to 10 grams of treated and untreated coffee beans were ground to a particle size suitable for solvent extraction. The ground samples were extracted using an aqueous methanol solution and filtered prior to chromatographic analysis. The resulting extracts were analyzed using a reverse-phase high-performance liquid chromatography system equipped with ultraviolet detection.

Chromatographic analysis focused on compounds associated with bitterness in roasted coffee, including chlorogenic acid lactones and quinic acid derivatives. The treated coffee samples exhibited a reduced relative abundance of chlorogenic acid lactones and related phenolic compounds when compared with the untreated control samples. In certain embodiments, the treated samples exhibited reductions of at least about 5%, and in further embodiments reductions of approximately 10% to approximately 35%, in selected bitterness-associated phenolic compounds while maintaining substantially unchanged caffeine levels relative to untreated samples, consistent with the relative thermal stability of caffeine in roasted coffee.

These results demonstrate that supercritical gas treatment according to the disclosed methods can modify the composition of roast-derived phenolic compounds in coffee materials.

### Example 4—Alternative Embodiments

In additional embodiments, the disclosed process may be applied to coffee materials at different stages of processing. For example, the supercritical or near-supercritical gas treatment may be applied to green coffee beans prior to roasting, partially roasted coffee beans, fully roasted beans, ground coffee materials, or coffee extracts or concentrates.

Treatment conditions may vary depending on the form of the coffee material and the desired degree of chemical modification. In various embodiments, pressures ranging from approximately 10 bar to approximately 400 bar and temperatures ranging from approximately 20° C. to approximately 80° C. may be employed. In preferred embodiments, pressures ranging from approximately 50 bar to approximately 350 bar and temperatures ranging from approximately 25° C. to approximately 70° C. may be used, while in more preferred embodiments pressures ranging from approximately 150 bar to approximately 300 bar and temperatures ranging from approximately 31° C. to approximately 60° C. may be employed. Treatment durations may range from approximately 5 minutes to approximately 48 hours, with certain embodiments employing treatment durations ranging from approximately 30 minutes to approximately 24 hours or longer.

Suitable pressurized gases may include carbon dioxide, nitrogen, argon, or mixtures thereof, which may be present under supercritical or near-supercritical conditions. Optional co-solvents such as ethanol or other food-compatible co-solvents may be introduced into the reactor in small quantities in order to enhance interaction between the pressurized fluid and phenolic compounds present in the coffee matrix.

### Example 5—Industrial Scale Implementation

In certain industrial embodiments, the disclosed process may be performed in pressure vessels capable of processing tens to hundreds of kilograms of coffee materials per batch. Commercial supercritical carbon dioxide processing systems may be used to expose coffee materials including roasted coffee beans to supercritical or near-supercritical fluids under controlled temperature and pressure conditions. Following treatment, the coffee materials may be depressurized, recovered, and packaged using conventional coffee processing equipment. Industrial systems may include gas recycling, heat exchange, and automated pressure control systems to improve processing efficiency.

It should be apparent, however, to those skilled in the art that many more modifications besides those already described are possible without departing from the inventive concepts herein, including additional alternative structural and functional designs as disclosed from the principles herein. Thus, while embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the apparatus and methods disclosed herein without departing from the spirit and scope of the disclosure. Thus, it is intended that the present disclosure covers the modifications and variations of the embodiments disclosed above provided that the modifications and variations come within the scope of any claims and their equivalents.

The inventive subject matter, therefore, is not to be restricted except in the spirit of the appended claims. Moreover, in interpreting both the specification and the claims, all terms should be interpreted in the broadest possible manner consistent with the context. Throughout this specification, some embodiments have used the expressions “comprises,” “comprising,” “includes,” “including,” “has,” “having,” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus. In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where the specification or claims refer to at least one of something selected from the group consisting of A, B, C, . . . and N, the text should be interpreted as requiring only one element from the group, not A plus N, or B plus N, etc.

As used herein any reference to any of “one embodiment” or “an embodiment,” “one variant” or “a variant,” and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the apparatus, article, method, or process illustrated may be made by those skilled in the art without departing from the disclosure. The foregoing description is of the best mode presently contemplated of carrying out the principles of the disclosure. This description is in no way meant to be limiting but rather should be taken as illustrative of the general principles of the technology. The scope of the disclosure should be determined with reference to the claims.

1. A method for treating a coffee material, comprising:
placing the coffee material in a pressure vessel;
exposing the coffee material to a critical-state gas; and
maintaining the coffee material under conditions of pressure and temperature sufficient to alter the relative concentration of one or more roast-derived phenolic compounds associated with bitterness.

2. The method of claim 1, wherein the coffee material is selected from the group consisting of roasted coffee beans, partially roasted coffee beans, green coffee beans, ground coffee, coffee extracts, and combinations thereof.

3. The method of claim 1, wherein the critical-state gas comprises a gas selected from the group consisting of carbon dioxide, nitrogen, argon, and mixtures thereof.

4. The method of claim 1, wherein the critical-state gas comprises carbon dioxide.

5. The method of claim 1, wherein the pressure within the pressure vessel is from approximately 10 bar to approximately 400 bar.

6. The method of claim 1, wherein the temperature within the pressure vessel is from approximately 20° C. to approximately 80° C.

7. The method of claim 1, wherein the coffee material is exposed to the critical-state gas for a duration of from approximately 5 minutes to approximately 48 hours.

8. The method of claim 1, further comprising introducing a co-solvent into the pressure vessel.

9. The method of claim 8, wherein the co-solvent comprises ethanol.

10. The method of claim 4, further comprising introducing ethanol as a co-solvent during exposure to the carbon dioxide.

11. The method of claim 8, wherein the co-solvent is present in an amount of from approximately 0% to approximately 20% by volume relative to the total treatment-fluid composition.

12. The method of claim 8, wherein the co-solvent is selected from the group consisting of alcohols, polyols, esters, ketones, ethers, organic acids, nitriles, water, and combinations thereof.

13. The method of claim 1, wherein the pressure vessel comprises a reactor selected from the group consisting of a stirred reactor, packed-bed reactor, fluidized-bed reactor, rotating pressure vessel, and continuous flow reactor.

14. The method of claim 1, further comprising depressurizing the pressure vessel after exposure of the coffee material to the critical-state gas.

15. The method of claim 1, wherein the critical-state gas is maintained under supercritical conditions throughout the treatment period.

16. The method of claim 1, wherein the coffee material is processed in a continuous reactor system.

17. The method of claim 1, further comprising grinding or comminuting the coffee material prior to exposure to the critical-state gas.

18. The method of claim 1, further comprising treating the coffee material with one or more enzymes capable of hydrolyzing chlorogenic acid lactones prior to exposure to the critical-state gas.

19. The method of claim 18, wherein the one or more enzymes are selected from the group consisting of esterases, tannases, hydrolases, lipases, and combinations thereof.

20. The method of claim 1, wherein altering the relative concentration of the one or more roast-derived phenolic compounds associated with bitterness comprises reducing the relative concentration of one or more chlorogenic acid lactones.

21. The method of claim 1, wherein altering the relative concentration of the one or more roast-derived phenolic compounds associated with bitterness comprises modifying a chromatographic profile of the one or more roast-derived phenolic compounds associated with bitterness relative to untreated coffee material.

22. The method of claim 1, wherein altering the relative concentration of the one or more roast-derived phenolic compounds associated with bitterness comprises reducing a relative abundance of one or more bitterness-associated phenolic compounds by at least about 5% relative to untreated coffee material.

23. A method for treating roasted coffee beans, comprising:
placing the roasted coffee beans in a pressure vessel;
exposing the roasted coffee beans to carbon dioxide under supercritical conditions in the presence of ethanol as a co-solvent; and
maintaining the roasted coffee beans under conditions of pressure and temperature sufficient to alter the relative concentration of one or more roast-derived phenolic compounds associated with bitterness.

24. A treated coffee material having a modified chromatographic profile of bitterness-associated phenolic compounds relative to untreated coffee material and substantially preserved caffeine content, wherein the treated coffee material is produced according to the method of claim 1.
